(19) United States
(12) Patent Application Publication
(10) Pub. No.: US 2012/0106211 A1
(43) Pub. Date: May 3, 2012

(54) POWER FACTOR AND LINE DISTORTION METHOD AND APPARATUS

(75) Inventors: Marco Corsi, Parker, TX (US); David Freeman, McKinney, TX (US); Fernando Mujica, Allen, TX (US)

(73) Assignee: Texas Instruments Incorporated, Dallas, TX (US)

(21) Appl. No.: 12/938,958

(22) Filed: Nov. 3, 2010

(51) Int. Cl. H02M 1/12

(52) U.S. Cl. 363/44; 307/31

(57) ABSTRACT

Today, power distribution systems can be used to supply power to many loads, and since many loads, such as servers, are reactive (i.e., have capacitors and/or inductors), line distortion and power factor can be an issue. Conventional techniques to correct for line distortion and power factor use a specialized circuit that is generally in series with the load, but these specialized circuits can be prohibitively expensive when used in large numbers. Here, however, a corrective power supply has been provided, which can correct for other parallel power supplies that can reduce cost.

### TECHNICAL FIELD

The invention relates generally to power conversion and, more particularly, to power factor and line distortion correction for an alternating current to direct current (AC-DC) system.

### BACKGROUND

Electrical power is distributed using electrical conductors and a high voltage AC signal ACIN. This signal ACIN is at 60 Hz in the United State and 50 Hz in other parts of the world. In order to minimize the losses in distribution, it is generally important that the voltage and current waveforms are in phase; however, a reactive or capacitive load will generally shift the phase of the current and voltage waveforms leading to increased transmission losses. Such a shift can be easily corrected with the addition of an inductor or a capacitor or some combination of the two. Generally, a power factor correction circuit is coupled in series with the power supply to achieve such as result, which can be seen in FIG. 1. In FIG. 1, an example of a power supply 100 can be seen. As shown, the power supply 100 generally comprises a AC-DC converter 102, a DC rail 104, a DC-DC converter 106, and a load 108. In operation, the AC-DC converter 102 receives an AC input signal ACIN from a main line and converts the signal ACIN to a DC signal, which is provided to DC rail 104. DC-DC converter 106 can then use the DC signal to power the load 108. Here, the AD-DC converter 102 provides power factor and line distortion correction, using inductor-capacitor (LC) circuitry engineered to generally ensure matching.

Turning to FIG. 2, AC-DC converter 102 (which includes power factor correction) can be seen in greater detail. As shown, AC-DC converter 102 generally comprises an AC-DC conversion stage 208 and DC-DC conversion stage 210. Generally, the transformer 202 steps-down or steps-up the AC signal ACIN (i.e., 120VAC to 50VAC), which is then rectified by diode bride 204. DC-DC conversion stage 210 (which, for example and as shown, is a boost converter having an inductor L, diode D1, switch S1, and capacitor C1) then generates an output signal IDC for DC rail 104. If controller 206 modulates the duty cycle of the switch S1 (that is switched at a frequency significantly higher than the 50 Hz or 60 Hz of the mains, such as 10 kHz) correctly, the incoming current waveform (of signal AIN) can be made to match the voltage waveform (of signal AIN). The output of this converter 102 can then be further regulated with a DC-DC converter 106 to power whatever load is being powered.

There are, however, some problems with this arrangement. Many modern loads (computers, for instance) create additional complications by loading the system with a current waveform that has significant distortion. This distortion is more difficult to correct, and circuits similar to AC-DC converter 102 usually have residual distortion in the current waveform. Additionally, such circuit can be prohibitively expensive. Therefore, there is a need for an improved system.

Some other conventional circuits are: U.S. Pat. No. 6,014,322; U.S. Pat. No. 6,031,749; U.S. Pat. No. 6,731,524; U.S. Patent Pre-Grant Publ. No. 2004/0150377; PCT Publ. No. WO2002095913; and Chattopadhyay et al. “Digital Implementation of a Line Current Shaping Algorithm for Three Phase High Power Factor Boost Rectifier Without Input Voltage Sensing,” IEEE Transactions on Power Electronics, Vol. 19, No. 3, May 2004, pp. 709-721

### SUMMARY

A preferred embodiment of the present invention, accordingly, provides an apparatus. The apparatus comprises an alternating current to direct current (AC-DC) conversion stage that is adapted to receive an AC input signal, wherein the AC signal has an input current and an input voltage; a current sensor that is adapted to receive a distorted AC signal; a DC-DC conversion stage that includes: conversion circuitry that is coupled to the AC-DC conversion stage; an analog-to-digital converter (ADC) that is coupled to the current sensor; and a processor with a storage medium having a computer program embodied thereon, wherein the processor is coupled to the ADC, and wherein the processor provides a control signal to the conversion circuitry, and wherein the processor adjusts the control signal so that the sum of currents for all loads for the AC signal is in phase with the input voltage and is generally undistorted.

In accordance with a preferred embodiment of the present invention, the conversion circuitry further comprises boost conversion circuitry.

In accordance with a preferred embodiment of the present invention, the boost conversion circuitry further comprises: an output terminal; an inductor that is coupled to the AC-DC conversion stage; a diode that is coupled to the inductor and the output terminal; a switch that is coupled between the inductor and ground, wherein the switch receives the control signal; and a capacitor that is coupled between the output terminal and ground.

In accordance with a preferred embodiment of the present invention, the processor further comprises a digital signals processor (DSP).

In accordance with a preferred embodiment of the present invention, the AC-DC conversion stage further comprises: a transformer that is adapted to receive the AC input signal; and a diode bridge that is coupled to transformer and the inductor.

In accordance with a preferred embodiment of the present invention, the current sensor further comprises a first current sensor, and wherein the apparatus further comprises a second current sensor that receives the AC input signal so as to measure the input current.

In accordance with a preferred embodiment of the present invention, the ADC further comprises a first ADC, and wherein the DC-DC conversion stage further comprises a second ADC that is coupled between the second current sensor and the DSP.

In accordance with a preferred embodiment of the present invention, an apparatus is provided. The apparatus comprises an AC-DC conversion stage that receives an AC input signal, wherein the AC input signal has an input current and an input voltage and an input voltage; a power supply that receives a distorted AC input signal; a primary load that is coupled to the power supply; a secondary load; a DC-DC conversion stage that includes: conversion circuitry that is coupled to the AC-DC conversion stage and to the secondary load; an ADC that is coupled to the current sensor; a processor with a storage medium having a computer program embodied thereon, wherein the processor is coupled to the ADC, and wherein the processor provides a control signal to the conversion circuitry, and wherein the processor adjusts the control signal so that the sum of currents for primary and secondary loads for the AC signal is in phase with the input voltage and is undistorted.

In accordance with a preferred embodiment of the present invention, the power supply further comprises a plurality of power supplies that are coupled in parallel to one another so as to receive the distorted AC signal.

In accordance with a preferred embodiment of the present invention, an apparatus is provided. The apparatus comprises an AC-DC conversion stage that receives an AC input signal, wherein the AC input signal has an input current and an input voltage and an input voltage; a plurality of power supplies that are each coupled in parallel with one another so as to receive a distorted AC signal; a DC rail that is coupled each power supply; a plurality of primary loads coupled to the DC power rail; a secondary load; a DC-DC conversion stage that includes: conversion circuitry that is coupled to the AC-DC conversion stage and to the secondary load; an ADC that is coupled to the current sensor; a processor with a storage medium having a computer program embodied thereon, wherein the processor is coupled to the ADC, and wherein the processor provides a control signal to the conversion circuitry, and wherein the processor adjusts the control signal so that the sum of currents for primary and secondary loads for the AC signal is in phase with the input voltage and is undistorted.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a circuit diagram of an example of a conventional power supply;

FIG. 2 is a circuit diagram of an example of the AC-DC converter of FIG. 1;

FIG. 3 is a circuit diagram of an example of an power supply system in accordance with a preferred embodiment of the present invention; and

FIG. 4 is a circuit diagram of an example a power supply of FIG. 4.

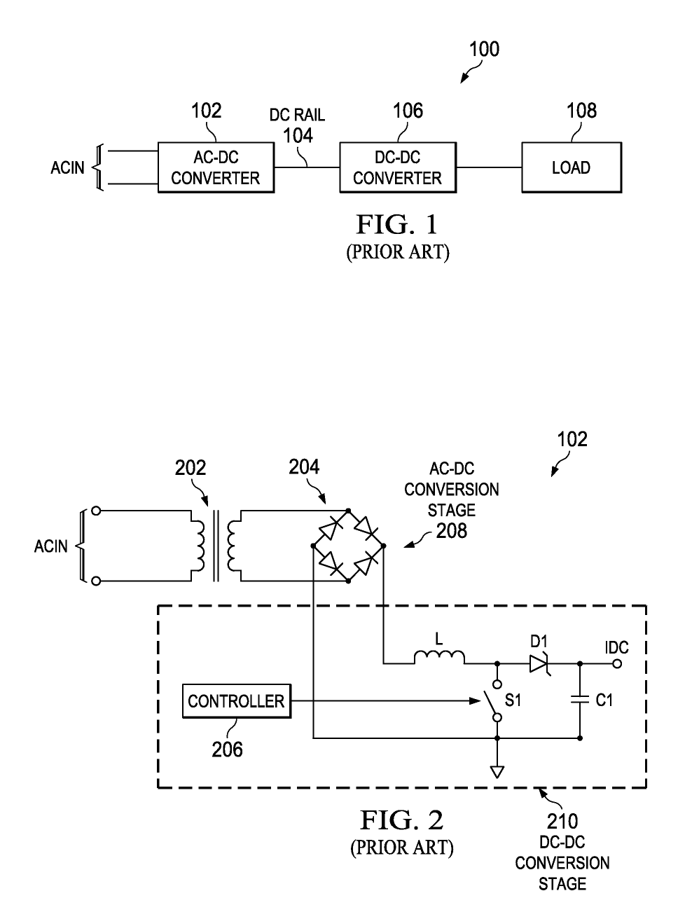

### DETAILED DESCRIPTION

Refer now to the drawings wherein depicted elements are, for the sake of clarity, not necessarily shown to scale and wherein like or similar elements are designated by the same reference numeral through the several views.

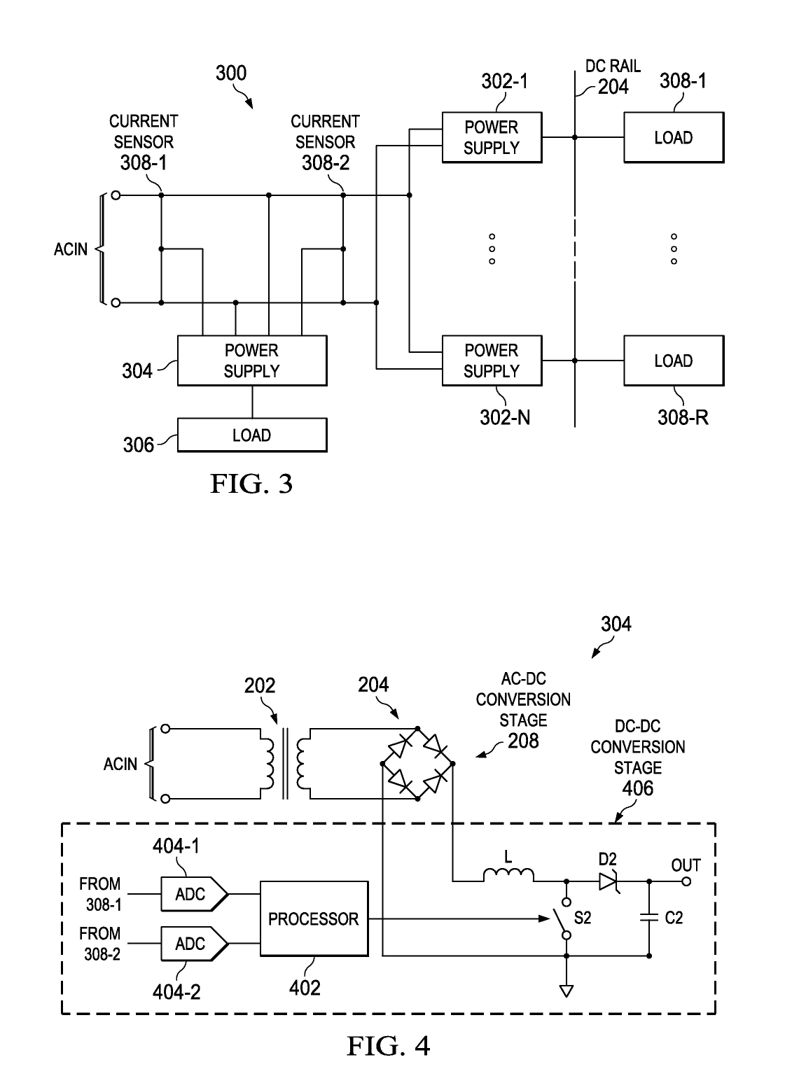

Turning to FIG. 3, an example of a power supply system 300 in accordance with a preferred embodiment of the present invention can be seen. As shown, power supplies 302-1 to 302-N (which can be conventional AD-DC power supplies) are generally coupled to a main line so as to receive an AC input signal ACIN and generate a DC signal for DC rail 204 (which, for example, can be a 450VDC rail). Loads 308-1 to 308-R (which can, for example, be servers and which are commonly referred to as “primary loads” or “primary load”) can be powered by DC rail 204. Additionally, power supply 304 and current sensors 308-1 and 308-2 are generally coupled to the main line. Power supply 304 can be an AD-DC converter, which powers load 302 (which can be referred to as a “secondary load”) and is generally dimensioned to correct for line distortion and power factor of the primary load (which should be a small percentage of system 300) based on information received from current sensors 308-1 and 308-2.

In FIG. 4, an example of power supply 304 can be seen in greater detail. Power supply 304 generally comprises AC-DC conversion stage 208 (similar to AC-DC converter 102) and a DC-DC conversion stage 406. The DC-DC conversion stage 406, as shown and for example, is a boost converter having a inductor L, schottky diode D2, switch S2, capacitor C2, processor 402, and analog-to-digital converters (ADCs) 404-1 and 404-2 (which typically can have distortion better than 100 dB). In operation, ADC 404-2 digitizes the current waveform of the primary load, which is generally provided by a current sense circuit or current sensor 308-2, and this digitized current waveform can then be used by the microcontroller or processor (which can, for example, be a digital signal processor or DSP) to control switch S2. Typically, processor 402 has a with storage medium (i.e., flash memory) having a computer program embodied thereon to implement such control. Generally, the computer program implemented by the processor 402 generally ensures that the sum of currents for all loads (i.e., loads 308-1 to 308-R and 306) is in phase with the input voltage (of signal ACIN) and shows low distortion (or is generally undistorted). Additional refinement can be achieved with the use of ADC 404-1 and current sensor 308-1. Alternatively, if the power used by load 306 can not be satisfied by the corrective distortion signal, then power supply 304 can simply extract power from the main at the fundamental frequency. This implementation can be provided through the computer program used or embodied on processor 402.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. An apparatus comprising:
an alternating current to direct current (AC-DC) conversion stage that is adapted to receive an AC input signal, wherein the AC signal has an input current and an input voltage;
a current sensor that is adapted to receive a distorted AC signal;
a DC-DC conversion stage that includes:
conversion circuitry that is coupled to the AC-DC conversion stage;
an analog-to-digital converter (ADC) that is coupled to the current sensor; and
a processor with a storage medium having a computer program embodied thereon, wherein the processor is coupled to the ADC, and wherein the processor provides a control signal to the conversion circuitry, and wherein the processor adjusts the control signal so that the sum of currents for all loads for the AC signal is in phase with the input voltage and is generally undistorted.

2. The apparatus of claim 1, wherein the conversion circuitry further comprises boost conversion circuitry.

3. The apparatus of claim 2, wherein the boost conversion circuitry further comprises:
an output terminal;
an inductor that is coupled to the AC-DC conversion stage;
a diode that is coupled to the inductor and the output terminal;
a switch that is coupled between the inductor and ground, wherein the switch receives the control signal; and
a capacitor that is coupled between the output terminal and ground.

4. The apparatus of claim 3, wherein the processor further comprise a digital signals processor (DSP).

5. The apparatus of claim 4, wherein the AC-DC conversion stage further comprises:
a transformer that is adapted to receive the AC input signal; and
a diode bridge that is coupled to transformer and the inductor.

6. The apparatus of claim 4, wherein the current sensor further comprises a first current sensor, and wherein the apparatus further comprises a second current sensor that receives the AC input signal so as to measure the input current.

7. The apparatus of claim 6, wherein the ADC further comprises a first ADC, and wherein the DC-DC conversion stage further comprises a second ADC that is coupled between the second current sensor and the DSP.

8. An apparatus comprising:
an AC-DC conversion stage that receives an AC input signal, wherein the AC input signal has an input current and an input voltage and an input voltage;
a power supply that receives a distorted AC input signal;
a primary load that is coupled to the power supply;
a current sensor that receives the distorted AC signal;
a secondary load;
a DC-DC conversion stage that includes:
conversion circuitry that is coupled to the AC-DC conversion stage and to the secondary load;
an ADC that is coupled to the current sensor;
a processor with a storage medium having a computer program embodied thereon, wherein the processor is coupled to the ADC, and wherein the processor provides a control signal to the conversion circuitry, and wherein the processor adjusts the control signal so that the sum of currents for primary and secondary loads for the AC signal is in phase with the input voltage and is undistorted.

9. The apparatus of claim 8, wherein the conversion circuitry further comprises boost conversion circuitry.

10. The apparatus of claim 9, wherein the boost conversion circuitry further comprises:
an output terminal;
an inductor that is coupled to the AC-DC conversion stage;
a diode that is coupled to the inductor and the output terminal;
a switch that is coupled between the inductor and ground, wherein the switch receives the control signal; and
a capacitor that is coupled between the output terminal and ground.

11. The apparatus of claim 10, wherein the processor further comprise a DSP.

12. The apparatus of claim 11, wherein the AC-DC conversion stage further comprises:
a transformer that is adapted to receive the AC input signal; and
a diode bridge that is coupled to transformer and the inductor.

13. The apparatus of claim 11, wherein the current sensor further comprises a first current sensor, and wherein the apparatus further comprises a second current sensor that receives the AC input signal so as to measure the input current.

14. The apparatus of claim 13, wherein the ADC further comprises a first ADC, and wherein the DC-DC conversion stage further comprises a second ADC that is coupled between the second current sensor and the DSP.

15. The apparatus of claim 8, wherein the power supply further comprises a plurality of power supplies that are coupled in parallel to one another so as to receive the distorted AC signal.

16. An apparatus comprising:
an AC-DC conversion stage that receives an AC input signal, wherein the AC input signal has an input current and an input voltage and an input voltage;
a plurality of power supplies that are each coupled in parallel with one another so as to receive a distorted AC signal;
a DC rail that is coupled each power supply;
a plurality of primary loads coupled to the DC power rail;
a secondary load;
a DC-DC conversion stage that includes:
conversion circuitry that is coupled to the AC-DC conversion stage and to the secondary load;
an ADC that is coupled to the current sensor;
a processor with a storage medium having a computer program embodied thereon, wherein the processor is coupled to the ADC, and wherein the processor provides a control signal to the conversion circuitry, and wherein the processor adjusts the control signal so that the sum of currents for primary and secondary loads for the AC signal is in phase with the input voltage and is undistorted.

17. The apparatus of claim 16, wherein the conversion circuitry further comprises boost conversion circuitry.

18. The apparatus of claim 17, wherein the boost conversion circuitry further comprises:
an output terminal;
an inductor that is coupled to the AC-DC conversion stage;
a diode that is coupled to the inductor and the output terminal;
a switch that is coupled between the inductor and ground, wherein the switch receives the control signal; and
a capacitor that is coupled between the output terminal and ground.

19. The apparatus of claim 18, wherein the processor further comprise a DSP.

20. The apparatus of claim 19, wherein the AC-DC conversion stage further comprises:
a transformer that is adapted to receive the AC input signal; and
a diode bridge that is coupled to transformer and the inductor.

21. The apparatus of claim 20, wherein the current sensor further comprises a first current sensor, and wherein the apparatus further comprises a second current sensor that receives the AC input signal so as to measure the input current.

22. The apparatus of claim 21, wherein the ADC further comprises a first ADC, and wherein the DC-DC conversion stage further comprises a second ADC that is coupled between the second current sensor and the DSP.
